(19) United States
(12) Patent Application Publication
(10) Pub. No.: US 2008/0034212 A1
(43) Pub. Date: Feb. 7, 2008

(54) METHOD AND SYSTEM FOR AUTHENTICATING DIGITAL CONTENT

(76) Inventor: Emanuele Altieri, Santa Clara, CA (US)

Correspondence Address: MCCORMICK, PAULDING & HUBER LLP, CITY PLACE II, 185 ASYLUM STREET, HARTFORD, CT, 06103, US

(21) Appl. No.: 11/462,847

(22) Filed: Aug. 7, 2006

(51) Int. Cl. H04L 9/00

(52) U.S. Cl. 713/176; 380/44

(57) ABSTRACT

A method and system is described to authenticate the sender of digital content, by combining the functionality of a key distribution server with the one of a mail server. This system allows the distribution of a person's public key or keys by simply knowing that person's email address. Senders upload a public encryption key onto their account on a mail server and use the corresponding private key to digitally sign outgoing digital content. Recipients verify the digital signature of incoming digital content using the sender's public key, which can be easily downloaded from the mail server and account coordinates specified by the return address field of the digital content.

### FIELD OF THE INVENTION

The present invention relates to a method and system for authenticating digital content. More particularly, it relates to a method for authenticating the sender of electronic mail, digital music, digital videos, electronic documents, or similar digital content by combining the functionality of a key distribution server with a mail server.

### BACKGROUND OF THE INVENTION

Recipients of email messages and other digital content are frequently subject to spam, forgery, fraud, and other crimes. Authentication of digital content assures the recipients that the return address exists, that the sender of the digital content owns such address, and that the digital content was not tampered with during its transmission and subsequent delivery. Additionally, as a byproduct of the authentication process, recipients have an opportunity to inspect the credentials of the server hosting the return address and possibly verify the identity of the sender with such information as the sender's full name or employer.

Many different protocols exist today claiming to perform authentication of email messages. In reality, these protocols only validate the outgoing mail server from which a message originates. In other words, they check whether the server is authorized to relay email messages or not. However, these techniques fail in exposing a fake sender and even in such fundamental tasks as verifying the existence of a return address.

One known identification protocol is discussed in U.S. Pat. No. 6,986,049 to Delany, issued on Jan. 10, 2006. This patent involves the use of digital signatures for authenticating messages. However, this protocol has several limitations. First, it makes use of a public/private key pair only for each outgoing mail server. Second, the protocol relies on outgoing mail servers to digitally sign messages rather than client software. Third, the signature verification involves the download of the outgoing server's public key from a special DNS entry associated with the originating domain. Because of these limitations, authentication by this protocol only proves that an email message originated from an authorized server but says nothing about the sender of the message.

Another known protocol is Microsoft Sender ID, which is based on an older protocol called Sender Policy Framework (SPF). SPF allows the owner of an Internet domain to use special DNS records to specify which machines are authorized to transmit email for that domain. Receivers can then reject any email that claims to come from that domain but fails in a check against the IP addresses listed in the SPF record of the domain.

Both of these protocols filter out emails originating from an unauthorized mail server. However, these two protocols only authenticate the domain from which a message originates, and they do not authenticate the sender. The present invention overcomes this disadvantage by assigning a key pair to each user of the system. Client software is in charge of signing outgoing messages before they are transmitted through the network, which is done using the private key of the sender. The present invention proves that the sender owns the return address of the message, that the mail server hosting the return address is authentic, and that the sender is who he or she claims to be.

### SUMMARY OF THE INVENTION

An objective of the invention is to provide a method and system for authenticating digital content.

Another objective of the invention is to provide a method and system for authenticating the sender of digital content.

The present invention is a method for authenticating digital content. The first step is generating a public/private key pair for a sender of digital content. The second step is uploading the public component of the pair onto the sender's account. The third step is using the corresponding private key of the key pair to generate a digital signature for the outgoing digital content. The fourth step is sending the digital content to a recipient's server. The fifth step is verifying the digital signature associated with the digital content using the public component of the key pair.

### BRIEF DESCRIPTION OF THE DRAWINGS

FIG. 1 is a schematic illustration of a system for authenticating digital content in accordance with one embodiment of the present invention.

FIG. 2 is a schematic illustration of a system for authenticating digital content in accordance with another embodiment of the present invention.

### DETAILED DESCRIPTION OF THE PREFERRED EMBODIMENT

The present invention authenticates digital content. The digital content can be email, video, music, text documents, or any type of electronic media. Examples may reference a specific type of digital content; however, one of ordinary skill in the art would appreciate that the present invention can be applied to all types of digital content.

The authentication process of the present invention creates a collaboration between both the sending and receiving sides. In the authentication process, outgoing digital content contains some extra information needed by the recipients of the message to validate its authenticity. This information consists of a digital signature and a key identifier (KID).

As utilized hereinafter, a “key pair” is meant to generally refer to both the public key and its corresponding private key.

As utilized hereinafter, a “public key” is meant to generally refer to a piece of cryptographic information used to verify the digital signature generated by one and only one private key. Given today's technology, it is impossible to derive a private key from its corresponding public key. For this reason, a public key may be freely distributed.

As utilized hereinafter, a “private key” is meant to generally refer to a piece of cryptographic information used, among other things, to digitally sign any kind of data, such as an email message. The owner should keep this cryptographic key secret.

As utilized hereinafter, a “digital signature” is meant to generally refer to a very large alpha-numeric array of elements generated from some input data of any length (such as an email message) and a private key. The digital signature is unique to the given data and key that are used as inputs. The inverse of a digital signature function, that is, the verification function, requires the initial input data and the public component of the key pair used to generate the signature.

A digital signature serves two purposes. First, it guarantees that the contents of the digital content were not tampered with. Second, it proves that the digital content originated from the claimed sender. A digital signature is generated using a private key, which is kept secret by the sender on a local host. The corresponding public key is freely distributed so that the digital signature of the digital content can be verified. Together, the public key and the private key comprise a key pair. The public key is freely distributed by keeping the public key on the mail server hosting the return address of the outgoing message. Specifically, the key is uploaded onto the sender's account on that server, where it can be freely downloaded by anyone that requests it. Because multiple keys may be stored in the same account, a key identifier is utilized to specify which public key should be used to verify a signature.

The client software can generate a public/private key pair automatically, usually at the time the software is installed. Alternatively, the user may provide a key pair, with its public component possibly embedded in a certificate signed by a trusted Certificate Authority. In both cases, the public component of the key pair is copied into the sender's remote account.

A certificate is meant to generally refer to a public key bundled with additional information used for identification purposes. The owner of a certificate may be an individual user or a company. A certificate may be assigned to a server or to an individual user. A certificate should be digitally signed by a Certificate Authority to be trusted.

In copying the public key to the sender's account, a secure connection is established with the server hosting the user's account. The name of the server is determined by the last portion of the user's email address, starting after the “@” symbol. For instance, if the address is “john@example.com,” then a secure connection is established with example.com.

Then, the account belonging to the user is selected. The name of the account is determined by the first portion of the user's email address up to the “@” symbol. For instance, if the address is “john@example.com,” then the account “john” is selected.

Next, owner privileges are obtained. This may be achieved by providing a password or other authentication information associated with the account.

Finally, the new public key is added to the key database of the selected account. On success, the server returns an integer key identifier referencing the new key. This identifier is embedded in every outgoing digital content signed using the key's matching private component.

A key identifier is useful when multiple computers are used to send and receive digital content. The multiple computers could be a workstation, laptop computer, desktop computer, hand-held device, or any device capable of sending and receiving digital content. Each platform may hold a different key pair, whose public component needs to be uploaded onto the user's account. Multiple public keys may be in the same account, and each of them is associated with a unique KID.

When handling multiple accounts belonging to the same user, the client software may choose a different key pair for every account owned by the user, a single key pair for all accounts owned by the user, or any combination thereof.

In verifying the authenticity of incoming digital content, the digital content contains a digital signature and a key identifier. The authentication process simply comprises verifying the digital signature of any digital content using the public key of the sender. The public key of the sender is downloaded from the mail server and account coordinates specified in the return address field of the incoming message.

In order to verify the authenticity, a secure connection is established with the mail server specified in the return address field of the digital content. The name of the server is determined by the last portion of the return address, starting after the “@” symbol. For instance, if the return address is “john@example.com,” then a secure connection is established with example.com.

Then, the certificate of the mail server is examined. In particular, the certificate is checked for whether the certificate was signed by a trusted Certificate Authority, the Internet domain associated with the certificate matches the expected domain, and the certificate has not expired.

Next, the account belonging to the sender is selected. As stated above, the name of the account is determined by the first portion of the return email address up to the “@” symbol.

After that step, the public key associated with the KID that is embedded in the incoming digital content is retrieved. If the key is provided in the form of a certificate, the certificate is examined. In particular, it is determined whether the certificate was signed by a trusted Certificate Authority, the certificate has expired, the email address associated with the certificate matches the expected address, and the name of the owner matches the sender's name.

Once the public key of the sender is downloaded, it can be used to verify the digital signature of the message. A valid signature proves that the message was not tampered with, the return address of the message is valid, the sender owns the indicated return address, the sender is who he or she claims to be, and the mail server hosting the sender's account can be trusted.

Upon the successful authentication of the digital content, the sender definitely owns the return address of the digital content since only the sender could have placed the public key needed for signature verification into his account.

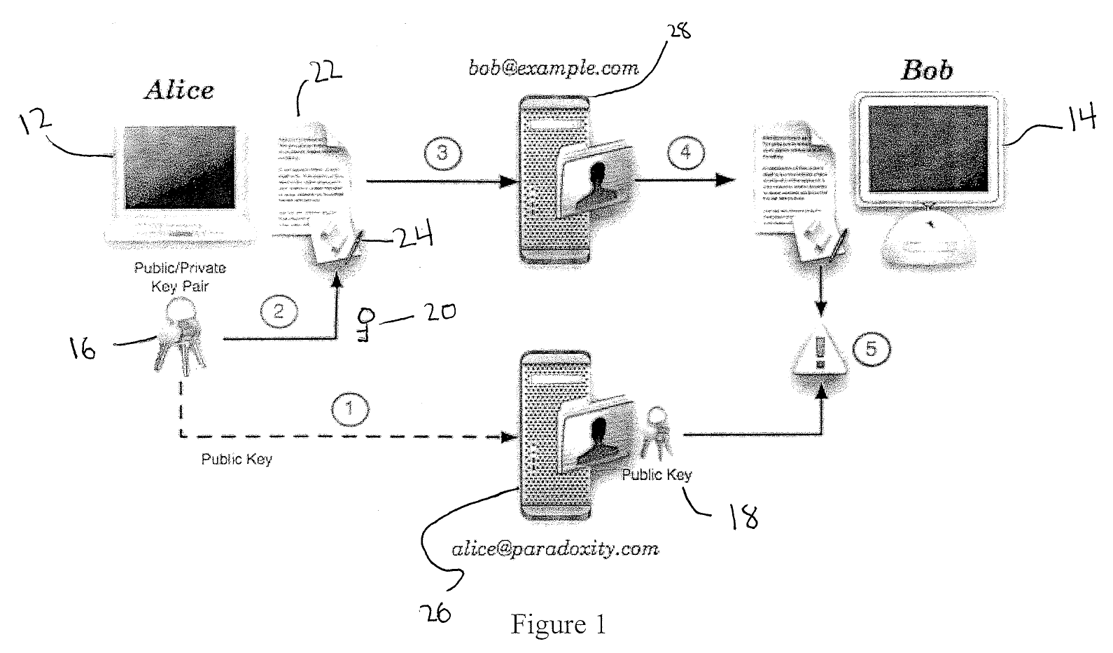

FIG. 1 shows one embodiment of the present invention. A sender 12 wants to send some digital content 22 to recipient 14. First, a public/private key pair 16 is generated for the sender 12. The public/private key pair consists of a public key 18 and a private key 20. The public component 18 of the pair 16 is uploaded into the sender's account 26 while the corresponding private key 20 is used to generate a digital signature 24 for the outgoing digital content 22. The digital content 22 is then sent to the recipient's server 28. Next, the recipient 14 downloads the digital content 22 and verifies its signature 24 using the sender's public key 18, which is available from the sender's account 26.

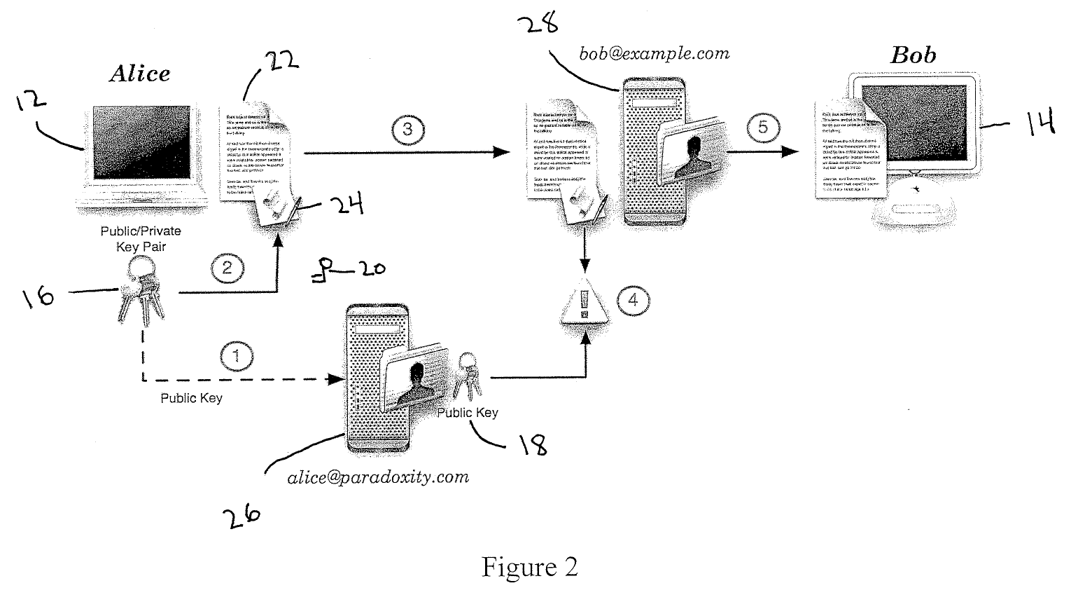

FIG. 2 illustrates another embodiment. In this embodiment, the recipient server 28 performs the authentication process in place of the recipient host 14. Therefore, the server 28 may act as a filter, allowing only authenticated digital content 22 to pass through and reach the recipient host 14.

As in FIG. 1, the steps begin when sender 12 sends digital content 22 to a recipient 14. First, a public/private key pair 16 is generated for the sender 12. The public component 18 of the pair 16 is uploaded into the sender's account 26 while the corresponding private key 20 is used to generate a digital signature 24 for the outgoing digital content 22. The digital content 22 is then sent to the recipient's server 28.

After this step, this embodiment differs from the previous embodiment. The recipient's server 28 verifies the digital signature 24 of the digital content 22 using the sender's public key 18, which can be downloaded from the sender's account 26. If the signature 24 is valid, the digital content 22 is stored in the recipient host 14 and later downloaded. If the signature 24 is not valid, then the digital content 22 is discarded.

After authenticating the digital content, the public key or certificate of its sender may be cached on the recipient's local host. If this is done, future digital content coming from the same sender can be authenticated immediately using the cached key as long as the KID in the message matches the KID of the cached key and the cached key has not expired.

In the presence of a key cache, the key identifier and digital signature from the received digital content is extracted. Then, it is determined whether a public key associated with the given sender and KID is present in the cache.

If the key is not cached, the public key of the sender is downloaded as described above. If the key is cached, then two scenarios are possible. If the public key is embedded in a certificate, then it is verified that the certificate has not expired. Otherwise, the key is checked at regular intervals throughout the life of the key to determine whether the key is still valid.

To determine whether a cached key is still valid, a secure connection is established with the server from which the cached key was originally downloaded. Then, the certificate of the server is examined. In particular, it is examined to verify that the certificate has not expired. Next, the account is selected from which the key was originally downloaded. The corresponding key database is queried from the KID of the cached key. A simply query is sufficient, it is not necessary to download the key data again.

After it has been determined that the cached key is still valid or that the certificate it was embedded in was not expired, the digital signature of the message is verified using the sender's public key. If the signature is valid and the sender's key was not cached, then the public key is added to the cache.

A key may be revoked by its owner or by a server administrator in the event that the corresponding private key is compromised. The key could also be periodically revoked as a security precaution, and then a newer key would regularly replace the key.

To limit the risk of using a compromised key, the recipient host can perform regular checks on the validity of a cached key before using it. The rate at which a cached key could be checked depends on the preferences and security needs of a given user.

Furthermore, the present invention can be layered on top of any network protocol used for the exchange of digital content. For instance, it can be used with SMTP, POP3, or IMAP, which are current protocols from the delivery and retrieval of email messages, as well as other proprietary protocols.

### EXAMPLES

The following examples show some embodiments of the present invention. The first example is illustrated by FIG. 1. Alice (alice@paradoxity.com) wants to send an email message to Bob (bob@example.com). First, a public/private key pair is generated for Alice. The public component of the pair is uploaded into Alice's account on paradoxity.com, while the corresponding private key is used to generate a digital signature for the outgoing message.

The email is then sent to the example.com mail server, where Bob owns a mailbox. Next, Bob downloads the new message from his mailbox and verifies its signature using Alice's public key, which is available from Alice's email account on paradoxity.com.

A second example is illustrated by FIG. 2. Alice (alice@paradoxity.com) wants to send an email message to Bob (bob@example.com). First, a public/private key pair is generated for Alice. The public component of the pair is uploaded into Alice's account on paradoxity.com, while the corresponding private key is used to generate a digital signature for the outgoing message.

The email is then sent to the example.com mail server, where Bob owns a mailbox. Bob's mail server verifies the digital signature of the message using Alice's public key, which can be downloaded from her email account on paradoxity.com. If the signature is valid, the email message is stored in Bob's mailbox and later downloaded by Bob. Otherwise, the email message is discarded.

The embodiments described above and shown in FIGS. 1-2 disclose a new method and system for authenticating digital content. One of ordinary skill in the art would appreciate that the present invention can be used on any hardware system such as a workstation, laptop computer, desktop computer, hand-held device, or any similar system. Further, one of ordinary skill in the art would appreciate that hardware systems are capable of communicating to each other through a digital, analog, wireless, or other similar signal.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A method for authenticating digital content, comprising:
generating a public/private key pair for a sender of digital content;
uploading the public component of said pair onto said sender's account;
using the corresponding private key of said pair to generate a digital signature for the outgoing digital content;
sending said digital content to a recipient's server;
verifying said digital signature associated with said digital content using said public component of said pair.

2. The method of claim 1, further comprising using a key identifier contained in said digital content to specify which public key to use in verifying said digital signature.

3. The method of claim 1, wherein said digital content is at least one of an email message, audio file, video file, or document.

4. The method of claim 1, wherein said public/private key pair is generated automatically by client software.

5. The method of claim 1, wherein said public/private key pair is provided by said sender.

6. The method of claim 1, further comprising examining a certificate of said sender's server.

7. The method of claim 1, further comprising caching said public component of said pair.

8. The method of claim 7, further comprising determining whether a public component of a pair associated with said sender is present in the cache.

9. The method of claim 8, further comprising checking said public component of said pair at regular intervals to determine whether said public component of said pair is still valid.

10. The method of claim 1, wherein said public component is embedded in a certificate.

11. The method of claim 10, wherein said certificate is examined.

12. The method of claim 10, further comprising caching said certificate.

13. The method of claim 12, further comprising verifying that said certificate has not expired.

14. A system for authenticating digital content, comprising:
client software that generates a public/private key pair for a sender of digital content, uploads the public component of said pair onto said sender's account, and generates a digital signature for the outgoing digital content using the corresponding private key of said pair;
said client software that sends said digital content to a recipient's server; and
said recipient's server that verifies said digital signature associated with said digital content using said public component of said pair.

15. The system of claim 14, wherein said sender's account creates a key identifier that references said uploaded public component of said pair.

16. The system of claim 14, wherein said digital content is at least one of an email message, audio file, video file, or document.

17. The system of claim 14, wherein said recipient's server examines a certificate of said sender's server.

18. The system of claim 14, further comprising a host that caches said public component of said pair.

19. The system of claim 18, wherein said host determines whether a public component of a pair associated with said sender is present in the cache.

20. The system of claim 19, wherein said host checks said public component of said pair at regular intervals to determine whether said public component of said pair is still valid.

21. The system of claim 14, wherein said public component of said pair is embedded in a certificate.

22. The system of claim 21, wherein said certificate is examined.

23. The system of claim 21, further comprising a host that caches said certificate.

24. The system of claim 23, wherein said host verifies that said certificate has not expired.

25. The system of claim 14, wherein said client software generates a different key pair for every account owned by said sender.

26. The system of claim 14, wherein said client software generates a single key pair for all accounts owned by said sender.

27. The system of claim 14, wherein said server delivers said digital content to a recipient host if said digital signature is valid and discards said digital content if said digital signature is not valid.

28. A system for authenticating digital content comprising:
client software that generates a public/private key pair for a sender of digital content, uploads the public component of said pair onto said sender's account, and generates a digital signature for the outgoing digital content using the corresponding private key of said pair;
said client software that sends said digital content to a recipient's server; and
a recipient host that downloads said digital content from said server and verifies said digital signature associated with said digital content using said public component of said pair.

29. The system of claim 28, wherein said sender's account creates a key identifier that references said uploaded public component of said pair.

30. The system of claim 28, wherein said digital content is at least one of an email message, audio file, video file, or document.

31. The system of claim 28, wherein said recipient host examines a certificate of said sender's server.

32. The system of claim 28, wherein said recipient host caches said public component of said pair.

33. The system of claim 32, wherein said recipient host determines whether a public component of a pair associated with said sender is present in the cache.

34. The system of claim 33, wherein said recipient host checks said public component of said pair at regular intervals to determine whether said public component of said pair is still valid.

35. The system of claim 28, wherein said public component of said pair is embedded in a certificate.

36. The system of claim 35, wherein said certificate is examined.

37. The system of claim 35, wherein said recipient host caches said certificate.

38. The system of claim 37, wherein said recipient host verifies that said certificate has not expired.

39. The system of claim 28, wherein said client software generates a different key pair for every account owned by said sender.

40. The system of claim 28, wherein said client software generates a single key pair for all accounts owned by said sender.
